(19) United States
(12) Patent Application Publication
(10) Pub. No.: US 2003/0083924 A1
(43) Pub. Date: May 1, 2003

(54) Multi-level audience processing

(76) Inventors: Yuchun Lee, Sudbury, MA (US); David F. Cheung, Potomac, MD (US); Ruby L. Kennedy, Bedford, MA (US); John C. Wells, Weston, MA (US); Shiao-Bin Soong, Littleton, MA (US); Robert C. Swiston, W. Newton, MA (US)

Correspondence Address: FISH & RICHARDSON PC, 225 FRANKLIN ST, BOSTON, MA, 02110, US

(21) Appl. No.: 10/001,190

(22) Filed: Oct. 31, 2001

(51) Int. Cl. G06F 17/60

(52) U.S. Cl. 705/10

(57) ABSTRACT

A method of conducting a marketing campaign includes accessing a database in which potential contacts are arranged in a hierarchy by defining a plurality of target audience levels during a table mapping process by key fields on the corresponding database, the key specifies how the target is uniquely identified, counted, and selected. The multiple tables are defined to translate from one level to another, where one of the keys is defined as the default or primary audience level key for the table and remaining keys are alternate keys to be used for switching between audience levels.

### BACKGROUND

This invention relates to data mining software for marketing programs.

When an organization conducts a direct marketing campaign, generally the organization is interested in selecting the best type of customer to send a promotional offer to. Traditionally, marketing databases used in such marketing campaigns define a particular head-of-household flag in the database to identify the target customer in a household. This solution provides a very static picture of the household. The database would contain a file structure having records that are arbitrarily marked to designate a contact. Such files force the user to arbitrarily pick one of several possible contacts. These solutions allow only single level audience processing and are not able to switch across audience levels.

In some other solutions a user can proceed down a hierarchy, e.g., starting from a household and then progress to customer. However, such solutions do not provide any mechanism to navigate back to the top of the hierarchy.

### SUMMARY

According to an aspect of the present invention, a method of conducting a marketing campaign includes accessing a database in which potential contacts are arranged in a hierarchy by defining a plurality of target audience levels during a table mapping process by key fields on the corresponding database, the key specifies how the target is uniquely identified, counted, and selected.

According to an additional aspect of the present invention, a method of conducting a marketing campaign includes accessing a database in which potential contacts are represented in multiple tables providing a plurality of target audience levels related by keys. The method also includes querying one of the tables in the database to find potential contacts matching characteristics of a campaign and switching queries to other tables in the database based on a different set of characteristics of the campaign.

One or more the following advantages may be provided by one or more aspects of the invention.

The invention allows implementation of many business rules in the context of an automated market campaign process. Multiple audience level processing can find individual entries that meet criteria and allow the user to make judgments about a set on a various levels or bases. Aspects of the invention allow a user to select the most appropriate target from multiple targets and to establish criteria for picking the best one rather than having an arbitrary rule of identifying the best contact.

The invention allows reading records from the database across multiple keys as opposed to having only one table and selecting against a single important key. It selects these records based upon inputs received through a graphical user interface from an operator. The invention provides the ability to traverse through a hierarchy of levels and allows the ability to select one from a group according to criteria, or the best set from a group according to some criteria.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a computer system executing marketing automation/campaign management software.

FIG. 2 is a block diagram of a record.

FIG. 3 is a block diagram of a representation of a relational database used to allow level switching in a marketing campaign.

FIG. 4 is a flow chart depicting a multiple level audience processing technique.

FIG. 5 is a flow chart depicting level switching based on the processing of FIG. 4.

FIGS. 6A and 6B are depictions of graphical user interfaces for multiple level audience processing.

### DETAILED DESCRIPTION

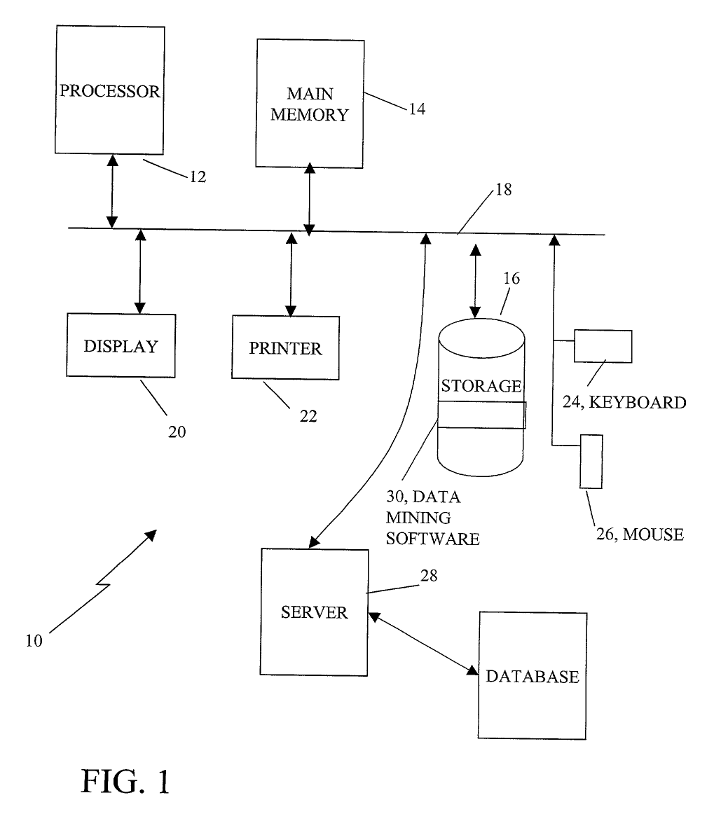

Referring now to FIG. 1, a computer system 10 includes a CPU 12, main memory 14 and persistent storage device 16 all coupled via a computer bus 18. The system 10 also includes output devices such as a display 20 and a printer 22, as well as user-input devices such as a keyboard 24 and a mouse 26. Not shown in FIG. 1 but necessarily included in a system of FIG. 1 are software drivers and hardware interfaces to couple all the aforementioned elements to the CPU 12.

The computer system 10 also includes marketing automation/Campaign Management software 30 that includes a relational database 32. The marketing automation/Campaign Management software 30 supports multi-wave, event-driven, scheduled, repeat, one-off, multi-stage, multi-channel, and longitudinal (relationship) campaign programs. The marketing automation/Campaign Management software 30 allows design and organization of marketing campaigns by breaking them into specialized Sessions. Basic session types can include a Data Preparation session, an Audience Selection session, a Modeling session and a Campaign session. The marketing automation/Campaign Management software 30 allows a user to modify or create campaigns using various automation tools. Icons can be used to represent distinct processes in the campaign. An indicator can displays the current status of each process.

The relational database 32 is designed to allow a user to conduct a marketing campaign and provide the user, e.g., a marketer and the like, the ability to work with multiple levels of data simultaneously. The marketing automation/Campaign Management 30 may reside on the computer system 10 or may reside on a server 28, as shown, which is coupled to the computer system 10 in a conventional manner such as in a client-server arrangement. The details on how this data mining software and relational database are coupled to this computer system 10 are not important to understand the present invention.

Generally, data mining software executes complex data modeling algorithms such as linear regression, logistic regression, back propagation neural network, Classification and Regression Trees (CART) and Chi squared Automatic Interaction Detection (CHAID) decision trees, as well as other types of algorithms that operate on a data set. Also, the data mining software can use any one of these algorithms with different modeling parameters to produce different results. The data mining software can render a visual representation of the results on the display 20 or printer 22 to provide a decision-maker with the results. The results that are returned can be based on different algorithm types or different sets of parameters used with the same algorithm.

Aspect of the marketing automation/Campaign Management software 30 operates on records that are stored in database 32 in a manner that allows multiple levels of switching between a target audience. The records can include predictive data derived from the modeling process discussed above.

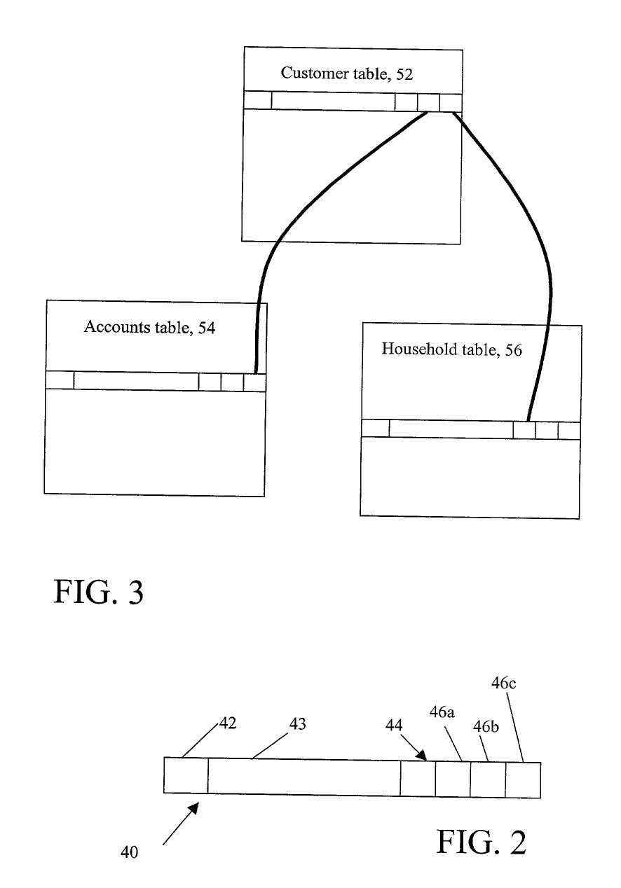

Referring now to FIGS. 2 a data set (not shown) includes a plurality of records with record 40 being illustrative. The record 40 can include an identifier field 42, as well as one or a plurality of fields 43 corresponding to input variable values that are used in the marketing automation/Campaign Management software 30. The record 40 also includes a plurality of result fields 44 that are used by the modeling process to record scores for the record 40. The scores are a measure of the expected behavior of a prospect represented by the record. The record 40 also includes key fields 46a-46c that are used to join and navigate between data base tables. Typically, for each of the records one of the fields would be a primary key for that record in the record's primary table and the others would be secondary keys for tables that it might join to according to some characteristic or search request. With these keys, the records are stored in the relational database 32 in a manner that allows switching between audience multiple levels.

Different types of tables can be defined. For example a Base Record Table would identify potential contacts (e.g., individuals, businesses, households, etc.) to which marketing campaigns are directed. This table minimally contains fields to identify each entity (represented as a record). It may also contain any number of foreign keys. A base record table is commonly referred to as a “base table.” A Dimension Table would include data that augments a base table (e.g., demographics based on a zip code, historical spending of a customer, etc.). An identifier (ID field) is specified for each dimension table to be used in defining its relationship with base record tables. A base table can be related to any dimension tables. However, a dimension table cannot relate to another dimension table.

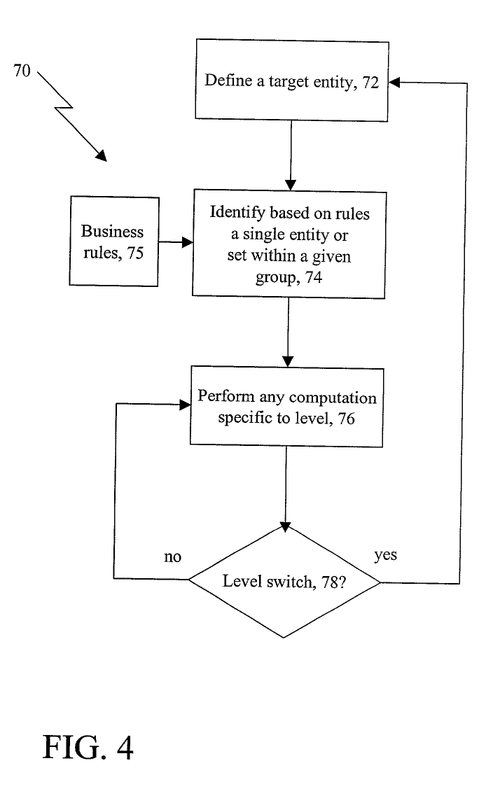

Referring to FIG. 3, using a retail banking campaign as an illustration, retail banks hold information about customers and addresses that might correspond to multiple customers, i.e., where two individuals have bank accounts and share the same address. In terms of the database representation, the database 32 can be organized to include a customer table 52, an account table 54 and an household table 56. Each of the tables 52-56 has a unique identifier or key within the database. A user of the data mining software extracts information from the tables 52-56 to make decisions. The campaign management software 30 produces joins across those tables 52-56. In contrast to typical market applications that require a single homogeneous table or data set the database 32 is comprised of distinct tables with distinct keying mechanisms.

An exemplary mapping for the banking example is shown in Table 1.

TABLE 1

| Database | | | Primary | Alternate | |
|---|---|---|---|---|---|
| Table | Table Name | Type | Key | Keys | Join to Table (Key Used) |
| Customer | CID_Cust | Base | CID | HH_ID | Account (CID) |
| Customer | HH_Cust | Base | HH_ID | CID | Account (CID) |
| Account | Account | Base | ACCT_ID | CID | — |
| Account | Acct_Dim | Dim | CID | — | CID_Cust (CID) |
| | | | | | HH_Cust (CID) |

Note in Table 1 that the Customer table is mapped twice as a base table, each time with a different primary key. Account table is mapped once as a base table and once as a dimension table to both Customer tables.

The marketing automation/Campaign Management software 30 in conjunction with the data mining software (not shown) allows a user to find those customers that fit a given set of criteria. The marketing automation/Campaign Management software 30 searches the customer table 52 for customers that meet the criteria. With the marketing automation/Campaign Management software 30 and the database 32, given customer keys 46b, the marketing software can determine for all those customers that share a household, which has a specific criterion, e.g., which one of the customers has the higher bank balance in the accounts table. That might be a criterion that is used to determine which of the persons in the household to send the offer to. The marketing software allows the user to traverse different criteria that are effectively joined together via the use of primary and secondary keys in the relational database 32. Thus, while there may be a head of the household, it might not be the correct person to send a marketing offer to in a given situation.

By looking at the account table 54 through this concept of audience switching allows the marketing software 30 to permit the user to correctly focus on decisions based on characteristics of the data. The audience processing in the marketing software 30 allows the user to switch from looking at the data through one key (e.g., customers) to another e.g., accounts by executing a database join and switching to a second key, e.g. 46c. Often in some instances the marketing software 30 will have the user return with a subset of results from accessing the second table, back to the first table and first key. This ability to be able to switch between keys allows the user to make correctly focused decisions based on the data that is in all of the tables rather than making arbitrary decisions ahead of time about how to create a combined table.

For instance the single table technique that holds all of the data requires the market application to determine, which one of the multiple customers with the common address is the more important customer to receive a qualifying offer. Single tables require arbitrary tagging of one of the people in the household as the head of the household or the key customer. In different marketing situations, different potential customers are the right persons to contact. The marketing software and database allow a user to pick the right person to contact by looking at the information from the point of view of each of the keys assigned to the tables.

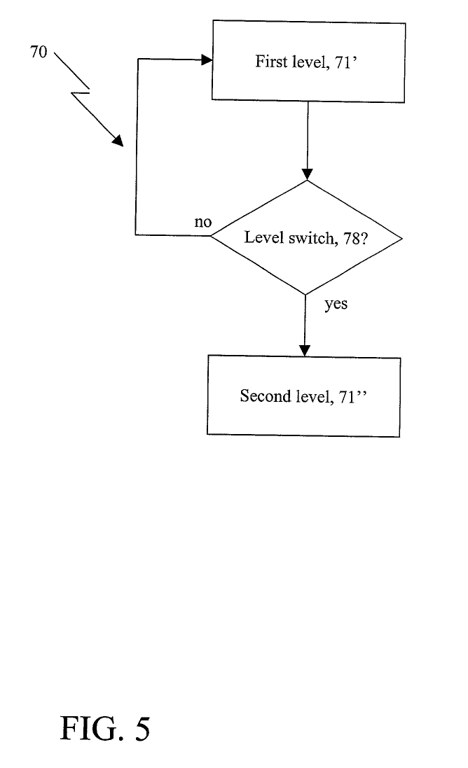

Referring now to FIG. 4, multiple audience level processing 70 defines 72 a target entity on which a marketer would like to work within the marketing campaign flow (e.g., customer, household, account, transaction, corporation, division, department, product, etc.). Most marketing data can be viewed hierarchically such that a household would be made up of multiple customers, a customer would hold multiple accounts, and an account would experience multiple transactions. MAP enables marketers to address issues of “house holding” and “level-switching” in a dynamic environment without being constrained by pre-defined data elements.

The term “house holding” is used generally to describe the process of reducing or expanding a current group of members at a current audience level by examining the current group via another audience level. For example, a marketer may want to identify 74 a single individual or a set of individuals within a given household to target based on a flexible marketing business rule 75. “Level-switching” provides the ability within complex marketing campaigns to process at different audience levels in order to arrive at a final set of target entities.

At each audience level, computations specific to that level may be performed 76 prior to switching to another level. For example, at that point complex data suppressions at that level can be performed. A marketer may be required to suppress customer-level records, switch to the account level, perform account-level suppressions, and finally switch back to the customer level for final contact. At some point in the processing the process 70 determines 78 if it is necessary to switch levels. If a level switch is executed the process 70 will execute a user-defined query to the database using a different key to access its corresponding, different table. If no switch is called for, the process 70 can exit or continue computations specific to the level, wait, and so forth. Thus, the potential contacts are represented by multiple tables.

For the household example, there could be a customer table where each customer would have a unique customer id and appropriate ones that lived in the same household would share a common household id. The household table would include for example, ages, demographics, and other data about the household. In the household table, would be information about the household, single family, value, address, postal code, etc. In the account table each account has a unique id that is associated with one or more customers. Typically, in an account table the accounts are not unique based on only the account number. The account table is unique in combination with one of the other keys because an account has two identifying entries, the account number and the owner.

Assume that there are two customers in the same household. One of the persons has an account and pays on time but the other person in the household is a bad credit risk. The marketer could have a rule that it is undesirable to send an offer to any customer in a household where at least one of the members of the household is a bad credit risk. Although one customer would qualify for the offer, the other with the bad rating would not. Without being able to switch between audience levels the marketer can send the offer to a household with a person having a good rating in a household with a person having a bad credit rating, which violates the marketer's basic rule. By level switching the user can find this bad credit risk in the household. Conversely, if the marketer has a rule that does not exclude a person with a good risk living in a household where there is a person with bad risk, then level switching could find this situation also.

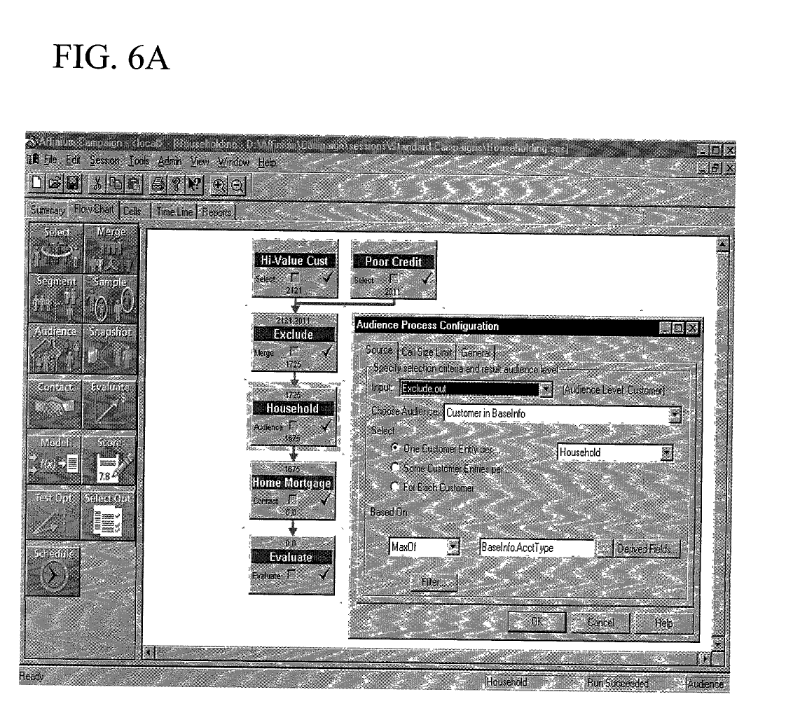

Still referring to FIG. 4 and also referring to FIG. 5, the process 70 initially starts 72 at the customer level for a first pass 71′. Each of the passes can include some, all or other actions besides those depicted in FIG. 4. The user runs a query for all people who have run a balance of at least $100 in the last year and have kept their payments up to date. A number of hits are returned including one of the two customers. The process 70 can apply 74 an exclusion rule 75′ that excludes 76 households when anyone in the household has a bad payment record. The MAP process enables the user to switch 78 up to the household level and find all those households where any member of the household has a bad credit record. For each of those, the user can then go back and find 72 other customers in that household. The process 70 finds 76 that the first customer shares the same address with the second customer. Thus, although the first customer qualified at the first level 71′, the first customer is now disqualified 76 at the second level 71″ because a member of the household is a bad credit risk.

The key relationships for each of the tables are defined during definition of the table. In the example, the customer table, for instance, would have a customer key and a household key. The account table would have an account key and a customer key. The different keys in the tables allow a user to join customers to households to accounts. To set up and use the audience process a user would map tables with multiple audience levels. These levels are defined within a single table provide a “look-up” to “translate” from one level to another. One key is defined as the “primary” or “default” key for the table. The other keys are “alternate” keys that are available for switching audience levels. While an unlimited number of audience levels can be defined and used, moving from one audience level to another requires both audience level keys to be defined within the same table.

MAP is used to look at marketing cell data, at one level and by adjusting programming logic allow the logic to switch levels to get a different perspective of the data. This is accomplished by using the program logic to find, e.g., “the best one” according to some criteria or all of the members with or without some criteria, i.e., finding a unique instance or finding all the instances that matches the particular selection criteria.

The multiple level audience process 70 permits a marketer to select the right sort of individuals to send an offer to. MAP affords the ability to traverse data in multiple ways. Audience processing logic allows a user to make inferences at multiple levels in the database before homing in on exactly which segment of the customer base to send an offer to and so forth.

MAP allows implementation of more business rules than just those focusing on individuals. MAP provides the ability to find individuals that meet criteria, then look up a set of individuals, for example, that belong to a household and make judgments about the set on a household basis, and then have that judgment reflect back on the individuals. MAP allows a user to select the most appropriate target from multiple targets and to establish criteria for picking the best one rather than having an arbitrary rule of identifying the head of the household as the contact.

MAP allows reading records from the database across multiple keys as opposed to having only one table and selecting against a single important key. It selects these records based upon inputs received through a graphical user interface from an operator. MAP provides the ability to traverse through a hierarchy of levels. MAP allows the ability to select one from a group according to criteria, or the best set from a group according to some criteria. Normally, with prior techniques the criteria have to be setup ahead of time that arbitrarily marks members.

The MAP process allows switching among, and work within different audience levels. Audience levels can be used to define the target entity with which a user desires to work such as in the examples noted above (e.g., account, customer, household, product, etc.). The levels are defined during the table mapping process. The MAP process allows a user to select all, some, or a single entity at one level in relationship to another level. The MAP process allows a user to specify an input table or cell, select the output audience level, select one, some, or all entries in a different audience level based on any field (including derived fields) or a query condition, automatically group over an audience level to select entries when multiple instances of that ID occur in a table (i.e., ID is not normalized within the table). The MAP processing also allows filtering of records (constraining records considered) before calculations are performed.

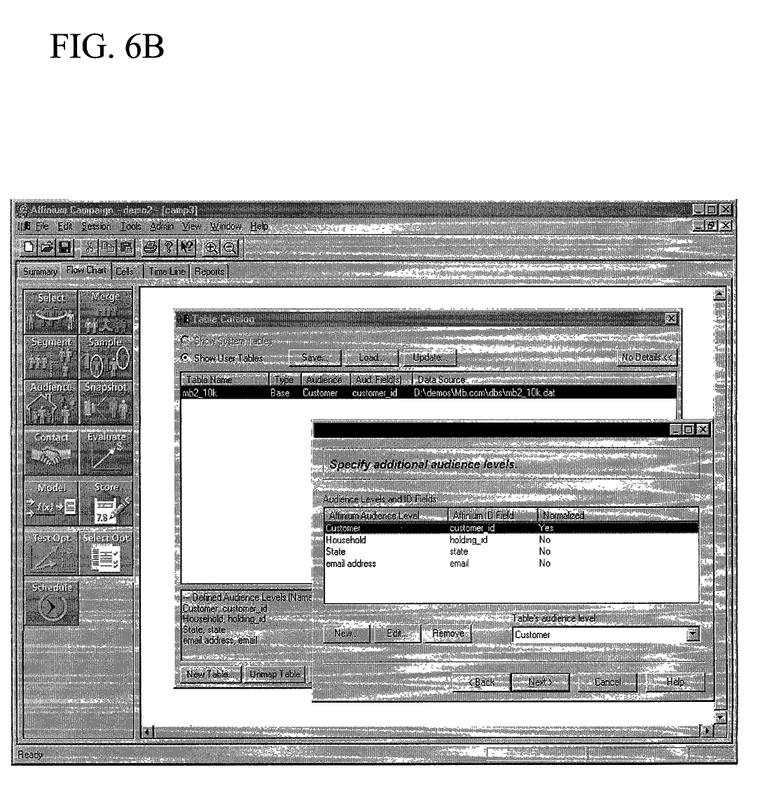

Referring to FIGS. 6A and 6B, graphical user interfaces for MAP processing are shown. In each figure, the buttons represent processes that operate in the automated marketing software 30. In this implementation visualization of a campaign can be provided using several campaign viewing Options.

One view is a Summary view that provides a text summary of the major aspects of the campaign. In addition to displaying the dates, descriptions, and objectives associated with each campaign, the Summary view also allows a view of what happened to each treatment, what modeling was used, and the financial results of each optimization. A second view is the Flow Chart view which displays the logical structure of the campaign. Double-clicking on an icon displays all the configuration parameters associated with that process. Another view is the Cells view. The Cells view displays a list of all cells associated with a campaign. For each cell, the cell population can be viewed in a spreadsheet format or s a cell profile information can be viewed in a graphical format as either a histogram or a cross-tabulation chart. A Timeline view shows campaign and event schedule and timing information on both a calendar and a Gantt chart, and a Reports view lets the user to view registered reports that can be exported as HTLM for sharing within an Intranet or Extranet environment. In FIGS. 6A and 6B the flow chart view is used.

FIG. 6A shows an audience processing configuration screen. The select Options box shows same Input and Output Audience Levels. A first option is “One <Input Audience Level>Entry per <Any Other Audience Level>.” Selecting this option allows the user to choose exactly one member of the input audience level scoped by another audience level (e.g., to select one customer per household). The user specifies a business rule to indicate how the single entity should be selected (min/max/median of some field). A second select option is “Some Customer Entries per <Any Other Audience Level>.” Selecting this option allows the user to select zero, one, or multiple members of the input audience level while examining by another audience level (e.g., to select all customers with above average purchases within the household). The “Based On” criteria supports keywords allowing the functional equivalent of a GROUPBY macro function to be performed. The “<Any Other Audience Level>” is the field grouped over and the <Input Audience Level>is the value returned. The user can specify the function to perform (e.g., SumOf, MaxOf, MinOf, AvgOf, etc.) and the field on which to operate.

The third option “For Each Customer” is selected to select members if the number of members at the selected audience level satisfies some condition, (e.g., number of accounts >1 or number of purchases >3). This option is available if the input audience level is not normalized (i.e., the record ID is not unique in the selected Choose Level table).

FIG. 6B shows a screen to specify audience processing levels. The screen of FIG. 6B allows a user to select the output audience level from the Choose Audience drop-down list. Available audience levels appear in the list. The list shows the audience level and the table in which it is defined. The relationship of the input and output audience levels define the available options on the rest of the screen.

In this embodiment these screens are defined in the Flow Chart view of the marketing automation/Campaign Management software 30.

A number of embodiments of the invention have been described. Nevertheless, it will be understood that various modifications may be made without departing from the spirit and scope of the invention. Accordingly, other embodiments are within the scope of the following claims.

What is claimed is:

1. A method of conducting a marketing campaign comprises;
accessing a database in which potential contacts are arranged in a hierarchy, by:
defining a plurality of target audience levels during a table mapping process by key fields on the corresponding database, the key specifies how the target is uniquely identified, counted, and selected.

2. The method of claim 1 wherein multiple tables are defined to translate from one level to another, where one of the keys is defined as the default or primary audience level key for the table and remaining keys are alternate keys to be used for switching between audience levels.

3. The method of claim 2 wherein a marketer uses the defined multiple audience levels, to switch between or work within these multiple levels within a marketing campaign flow.

4. The method of claim 2 wherein a marketer can specify an input table or cell at a particular audience level.

5. The method of claim 2 wherein a marketer can specify an output audience level.

6. The method of claim 2 wherein a marketer can select one, some, or all entries in a different audience level based on the data in another table field, derived field, or query condition.

7. The method of claim 2 wherein a marketer can automatically group over an audience level to select entries when multiple instances of that identifier occur in non-normalized tables.

8. The method of claim 2 wherein a marketer can filter records, to constrain specific records, prior to calculations or groupings.

9. A method of conducting a marketing campaign comprises;
accessing a database in which potential contacts are represented in multiple tables providing a plurality of target audience levels related by keys;
querying one of the tables in the database to find potential contacts matching characteristics of a campaign; and
switching queries to other tables in the database based on a different set of characteristics of the campaign.

10. The method of claim 9 wherein the multiple tables are defined to translate from one level to another.

11. The method of claim 9 wherein one of the keys on one of the tables is defined as the default or primary audience level key for the table and remaining keys are alternate keys to be used for switching between audience levels.

12. The method of claim 9 wherein a marketer uses the defined multiple audience levels to switch between or work within these multiple levels within a marketing campaign flow.

13. The method of claim 9 wherein a marketer can specify an input table or cell at a particular audience level.

14. A computer program product residing on a computer readable medium for conducting a marketing campaign comprises instructions for causing a computer to:
access a database in which potential contacts are represented in multiple tables providing a plurality of target audience levels related by keys;
query one of the tables in the database to find potential contacts matching characteristics of a campaign; and
switch queries to other tables in the database based on a different set of characteristics of the campaign.

15. The computer program product of claim 14 wherein the program allows a marketer to select one, some, or all entries in a different audience level based on the data in another table.

16. The computer program product of claim 14 wherein the program automatically groups records over an audience level.

17. The computer program product of claim 14 wherein the program allows a marketer to define key relationships for each of the tables during definition of the table.

18. The computer program product of claim 14 wherein the program allows a marketer to:
define a target entity that a marketer would like to work within the marketing campaign flow;
identify a single individual or a set of individuals to target based on a flexible marketing business rule;
process the identified set at different audience levels in order to arrive at a final set of target entities.
